(19) United States
(12) Patent Application Publication
(10) Pub. No.: US 2016/0326332 A1
(43) Pub. Date: Nov. 10, 2016

(54) SPECIAL MODIFIED EXPANDABLE POLYSTYRENE COPOLYMER PARTICLE FOR LOST FOAM AND PRODUCTION METHOD THEREFOR

(71) Applicant: ZHEJIANG CASTCHEM NEW MATERIAL CO.,LTD, Quzhou (CN)

(72) Inventors: Jianwei Zou, Quzhou (CN); Suoyun Tang, Quzhou (CN); Xiaohong Han, Quzhou (CN); Guohua Lu, Quzhou (CN)

(73) Assignee: ZHEJIANG CASTCHEM NEW MATERIAL CO.,LTD

(21) Appl. No.: 15/060,669

(22) Filed: Mar. 4, 2016

(30) Foreign Application Priority Data
May 4, 2015 (CN) 201510220113.7

(51) Int. Cl. C08J 9/20

(52) U.S. Cl. CPC C08J 9/20; C08J 2325/14

(57) ABSTRACT

The present invention discloses a special modified expandable polystyrene copolymer particle for a lost foam, which respectively comprises the following parts by weight: 90 to 100 parts of styrene; 3 to 8 parts of methyl methacrylate; 100 to 140 parts of deionized water; 0.2 to 0.5 part of benzoyl peroxide; 0.2 to 0.5 part of dicumyl peroxide: 0.1 to 0.5 part of tert-butyl peroxybenzoate: 0.001 to 0.01 part of anionic surfactant; 1 to 2 parts of suspension concentrate; 5.0 to 10.0 parts of foaming agent; 0.1 to 0.4 part of nucleator; 0.2 to 2 parts of organic bromine; 0.01 to 0.1 part of molecular weight regulator having the effect of increasing molecular weight, and 0.3 to 0.5 part of surface coating agent. The special modified expandable polystyrene copolymer particle for the lost foam and a production method therefor of the present invention effectively solve the existing problem of no special EPS for lost foam casting, and have the advantages of reducing the generation of a carbon defect problem during foundry of a casting and increasing the molecular weight.

### CROSS-REFERENCE TO RELATED APPLICATIONS

This application claims priority to, Chinese Patent Application No. 201510220113.7 with filing date of May 4, 2015. The content of the aforementioned application, including any intervening amendments thereto, is incorporated herein by reference,

### TECHNICAL FIELD

The present invention relates to the field, of lost foam casting material, and more particularly to a special modified expandable polystyrene copolymer particle for a lost foam and a production method therefor.

### BACKGROUND OF THE PRESENT INVENTION

Lost foam casting (also known as full mold casting) is a novel casting method which comprises: bonding and combining paraffin or foam model having similar size and shape with a casting to form a model duster; after brushing refractory coating and drying by baking, burying the same into dry quartz sand and vibration molding: casting at negative pressure so as to gasify the model; enabling liquid metal to occupy the position of the model; and after solidifying and cooling, forming a casting,

Compared with traditional send mold casting, the lost foam casting has many obvious advantages. For example: 1. The lost foam casting does not need typing and coring up, so it is particularly suitable for box body type and shell type castings and bobbin type castings which have complicated geometrical shapes and which are difficult to finish by traditional casting. 2. The lost foam casting uses dry sand to bury the model, and the dry sand can be repeatedly used so industrial garbage is less and the cost is obviously reduced. 3. No flash or burr exists in the lost foam casting, so cleaning hours can be reduced by more than 80%, 4. The lost foam casting can be used in multiple production lines. It not only can be used for making iron castings and magnesium iron, but also can be used for making steel castings. Therefore, shifting is flexible and the application scope is wide. 5. The lost foam casting not only is suitable for large-batch castings for performing mechanized operation, but also suitable for small-batch products for manually splicing the model. 6. If the lost foam casting is invested in place, dust in the air no send on the ground, low labor intensity, and good working environment can be realized; and the industry dominated, by male workers is changed into the industry dominated by female workers, 7. The lost foam casting cancels shaping procedure. People having certain cultural level can become skilled workers after being trained for short time. Therefore, the lost foam casting is particularly applicable to regions and enterprises that lack of technical force. 8. The lost foam caning is suitable for group casting; it is easy to sand out for dry sand burying type; residual heat treatment can also be performed on castings of some materials according to purposes. 9. The lost foam casting not only is suitable for small and medium castings, but also is suitable for large castings, such as: machine tool body, large-caliber pipes, large cold stamping dies, large mine equipment fittings, etc.

The existing lost foam casting has the following defects:

1. There is no special polystyrene foam (EPS for short) for the lost foam casting process. At present, EPS for packaging is used as a substitute for screening residual material. The EPS for packaging is formed by polymerization of a styrene monomer. Its molecular weight is as low as about 50000, causing insufficient strength and rigidity and no applicable for the lost foam casting.

2. When the polystyrene foam (EPS) pattern for packaging is used in the lost foam casting, during casting, some segments with weaker bond energy in the polystyrene foam for packaging are broken firstly with the rise of the temperature; with the continuous rise of the temperature, segments with stronger bond energy are also broken; then, a plurality of hydrocarbon compounds with lower molecular weight are formed. Moreover, in these hydrocarbon compounds, some chemical compounds with carbon-carbon double bonds and carbon-carbon triple bonds also exist. It is well known that in an organic compound, the larger the proportion of carbon atom in the whole molecule is, the easier the generation of black smoke is in burning process. The black smoke is caused by incomplete burning of the organic compound. Similarly, the organic compound with higher content of the carbon atom is easier to generate a carbonization phenomenon in heating decomposition process. It is also obvious that the organic compounds with carbon-carbon double bonds and carbon-carbon triple bonds have high carbon content in molecules. In the compounds, because the proportion of the carbon atom in the whole molecule is larger, in further heating process, it is easy to generate carbonization. Because the carbon atom is still at high temperature state after the carbonization and the carbon atom has larger activity, the carbon atom enters the castings and generates the carbon defect. The carbon increase amount of EPS pattern on the surfaces of steel castings 0. to 0.5%. The EPS pattern is the most attractive in iron casting, and shows wrinkle, cooling scarring, surface depression and subsurface slag inclusion, causing a great influence on the mechanical property of the casting. At present, there is no good method for fully solving the defect in China. This is also a reason why numerous casting manufacturers do not dare to adopt the lost foam or cannot perform batch production after adopting a lost foam production line.

Especially in aluminum casting, carbon inclusions become the main problem in the lost foam casting process. The carbon inclusions appear when “cold shut” is caused because two metal streams encounter but do not be soaked and melted mutually. If the castings are heated circularly and cooled one by one, the carbon inclusions also cause fatigue fracture of metal; if the defect of the carbon inclusions exists in one aluminum casting, generally, the defect of the carbon inclusions will appear in each casting. Under some conditions, in case of the castings themselves, when the defect does not exist in the important region of the castings, it is not a serious problem. However, for some castings like engine cylinder bodies, because the tests of high and low temperature circular change and pressure are born, if the carbon inclusions appear in the important region and cause that the liquid leaks in the castings, an extremely serious fault is caused.

### SUMMARY

With respect to the defects in the prior art, the first purpose of the present invention is to provide a special modified expandable polystyrene copolymer particle for a lost foam for more effectively reducing the generation of a carbon defect problem during foundry of a casting.

The second purpose of the present invention is to solve the problems of ultralow molecular weight, low strength and low rigidity of the existing EPS.

To realize the above purposes, the present invention provides the following technical solution: A special modified expandable polystyrene copolymer particle for a lost foam respectively comprises the following parts by weight: 90 to 100 parts of styrene; 3 to 8 parts of methyl methacrylate; 100 to 140 parts of deionized water; 0.2 to 0.5 part of benzoyl peroxide; 0.2 to 0.5 part of dicumyl peroxide; 0.1 to 0.5 part of tert-butyl peroxybenzoate; 0.001 to 0.01 part of anionic surfactant; 1 to 2 parts of suspension concentrate; 5.0 to 10.0 parts of foaming agent; 0.1 to 0.4 part of nucleator; 0.2 to 2 parts of organic bromine; 0.01 to 0.1 part of molecular weight regulator having the effect of increasing molecular weight, and 0.3 to 0.5 part of surface coating agent.

In the present invention, through the use of the new polymer modified expandable polystyrene copolymer particle generated by polymerization of the methyl methacrylate and the styrene, the molecular weight is increased; meanwhile, the generation of the carbon defect problem is reduced through the combined use of the organic bromine and the methyl methacrylate. When heated, the organic bromine generates hydrogen bromide; the hydrogen bromide generates addition reactions with carbon-carbon double bonds and carbon-carbon triple bonds; on one hand, after the addition reactions are generated, the original carbon-carbon double bonds and carbon-carbon triple bonds are broken so that the proportion of carbon atom in the whole molecule is decreased, while the carbon defect in the casting is generated mainly due to the existence of the carbon-carbon double bonds and the carbon-carbon triple bonds formed by heating the polymer; carbonization is reduced to a certain extent; secondly, the relative molecular as of bromine atom is greater than that of hydrogen atom; with the comparison of the modified expandable polystyrene copolymer particle polymerized by the methyl methacrylate with the existing polystyrene foam, the proportion of carbon element is greatly reduced; and the generation of the carbon defect can be effectively reduced through the decrease of carbon content.

In addition, the organic bromine is often used for fire retardation, while the modified expandable polystyrene copolymer particle is an inflammable article and can be ignited by fire, so particular care shall be taken in the process of storage and use, a fire source shall be strictly isolated, and attention shall be paid to the ventilation of production sites of raw material storehouses and the like. However, the addition of the organic bromine can effectively solve the defect that the modified expandable polystyrene copolymer particle is inflammable so that the modified expandable polystyrene copolymer particle is safer in use and easier in storage.

Further, the organic bromine is any of hexabromocyclododecane, tetrabromocyclooctane, tetrabromoethane and tetrabromophenol bis A/2/4/6-tribromo alkylphenyl allyl ether. In the present invention, hexabromocyclododecane is selected as the organic bromine. While the organic bromine reduces the carbon increase of the casting, hydrobromic acid can be generated during high temperature heating through the use of the organic bromine; a free radical can be generated; the polystyrene molecular weight can be reduced so that the material can be quickly liquified; when the organic bromine is used, squeezed melting fluid flows out like water; but when the organic bromine is not used, the melting fluid flows out like honey sugar. However, the hexabromocyclododecane is melted in particles, but not attached to particle surfaces. In this way, the fusion of the particles is not hindered when the particles are expanded into a plastic molded foam article.

Therefore, if the hexabromocyclododecane is used as the organic bromine, the density, the tensile strength the heat resistance and other physical and mechanical properties of the particles are not influenced. So the hexabromocyclododecane is selected to be used as the organic bromine in the present invention.

The molecular weight regulator is any of o-divinylbenzene, ethyleneglycol dimethacrylate and alkyl sulfhydryl or mixtures thereof. In the present invention, the dodecyl mercaptan is selected to be used as the molecular weight regulator. The dodecyl mercaptan can prevent excessive cross linking of functional groups so that the cohesive force of the polymers is proper. The use quantity of the dodecyl mercaptan can directly influence the magnitude of the molecular weight of the e polymers, and the dodecyl mercaptan is used for increasing the molecular weight of the polymers in the present invention.

The anionic surfactant is any of lauryl sulfate, stearate, dodecylbenzene sulfonate and dodecyl sulfonate. In the present invention, the sodium dodecyl benzene sulfonate is selected to be used as the anionic surfactant. When the above anionic surfactant is used, substances, which affect the polymerization, on the surfaces of plant grains can be eliminated so that the plant grains are easy to foam in a closed container and the molding and antistatic effect of the plant grains can be obviously enhanced.

The nucleator is granular and powdery polyolefin or polyolefin with small straight chains and branched chains. In the present invention, the polyethylene wax is selected as the nucleator. The use of the nucleator can accelerate the crystallization rate of the polymers and increase the crystallization density, while the polyethylene wax has the performance of low viscosity, high softening point, good hardness and the like, has no toxicity, has good heat stability and low high-temperature volatility, has excellent external lubrication performance and strong internal lubrication action for the dispersity of pigment, can increase the production efficiency of plastid processing, has good moisture resistance, strong chemical resistance capability and good electrical property at normal temperature, and can improve the appearance of a finished product. Meanwhile, because the polyethylene wax has the characteristics of excellent external lubrication action, strong internal lubrication action and good compatibility with the modified expandable polystyrene copolymer particle of the present invention, the polyethylene wax can be used as a lubricant in extrusion, tendering and injecting processing, an increase processing efficiency, can prevent and overcome films, pipes and sheets from bonding, can enhance the smoothness and the glossiness of finished products, and can improve the appearance of the finished products.

10. The foaming agent is any of butane, n-pentane, isopentane, cyclopentane, n-hexane, dichloromethane and fluorinated hydrocarbon or mixtures thereof. In the present invention, a mixture of n-pentane, isopentane and cyclopentane is selected to be used as the foaming agent. The proportion of the n-pentane to the isopentane is (3 to 7):(7 to 3). 0 to 0.5 part of cyclopentane is contained. The use quantity of the n-pentane, the isopentane and the cyclopentane can be determined, according to the material property of the finished products. In the foaming process, the foaming agent with high molecular weight has smaller diffusion loss than the foaming agent with low molecular weight, which is favorable for increasing foam expansion. In addition, The higher the boiling point of the foaming agent is, the larger the residual amount in EPS during shaping is. Therefore, the pentane with high molecular weight and low boiling point s selected as the foaming agent.

The surface coating agent is any of zinc steer to and aliphatic glyceride or mixtures thereof. In the present invention, a mixture of the zinc stearate and the alphatic glyceridea is selected as the surface coating agent. The proportion of the zinc stearate to the aliphatic glyceride is 1:1. The surface coating agent is used before packaging so as to prevent the particles from agglomerating during foaming.

The suspension concentrate is any of water-insoluble inorganic compound or water-soluble high molecular polymer. In the present invention, the used suspension concentrate is tricalcium phosphate. When the tricalcium phosphate is used as the suspension concentrate, the aqueous phase viscosity can be increased for increasing oil drop moving resistance and reducing the tension of an oil and water interface so as to increase the oil drop thermodynamic stability and effectively perform dispersive action. At the same time, When the tricalcium phosphate is used as the suspension concentrate, the phenomena of pulping and fouling can be effectively inhibited, thereby facilitating the reduction of the maintenance difficulty and expense of equipment and increasing production efficiency.

A production method for a special modified expandable polystyrene copolymer particle for lost foam comprises the following steps:

step 1: adding the deionized water into a reaction kettle; while stirring, successively adding the suspension concentrate, the surfactant, the styrene, the methyl methacrylate the benzoyl peroxide, the nucleator, the organic bromine, the molecular weight regulator, the dicumyl peroxide and the tert-butyl peroxybenzoate; after covering, uniformly mixing the same;

step 2: heating the reaction kettle at the temperature rise speed of 0.4 to 0.8° C./minute; and when the temperature rises to 80 to 90° C., keeping constant temperature for 400 to 600 minutes;

step 3: after covering, replacing with nitrogen the tunes and, pressing in the foaming agent;

step 4: heating the reaction, kettle at the temperature rise speed of 0.4 to 08° C./minute so that the reaction temperature reaches 120 to 130° C. and the pressure reaches 0.65 to 0,95 pa; and keeping the temperature and the pressure for 200 to 300 minutes;

step 5: cooling the reaction kettle with cooling water so that the temperature of the material in the kettle is lowered to 35 to 40° C.; and then, dehydrating drying and screening the material:

step 6: adding and stirring the surface coating agent so that the material and the surface coating agent are thoroughly mixed uniformly.

In the production process, because the benzoyl peroxide begins to decompose at 60° C. and volatilize at 3° C., after the process of first heating to 80 to 90° C. and keeping constant temperature for 400 to 600 minutes is finished there are a few monomer in polymer particles and the reaction speed is greatly reduced. Therefore, the temperature is heated to 120 to 130° C. again; and under the condition that the pressure each 0.65 to 0.95 mpa, the dicumyl peroxide and the tert-butyl peroxybenzoate are used for initiating and enabling the monomers to accelerate polymerization. After the polymerization is finished, the material is taken out, dried and screened; and finally, the surface coating agent is added for protecting the material, preventing the material from agglomerating and increasing the demouding rate of the product.

Through the adoption of the above technical solution, the present invention uses a one and half step process. The process between one-step method and two-step method, can reduce the production procedure, shorten the production time, simplify the production process, reduce the energy consumption, increase the automation degree of production and facilitate operational control.

In the polymerization reaction where the methyl methacrylate and the styrene are polymerized into the modified expandable polystyrene copolymer particle, at low temperature regulation, the polymerization action is first initiated through the benzoyl peroxide; after low-temperature granulation is ended, the monomers in the polymer particles are fewer and the reaction speed is greatly reduced. If the reaction time is prolonged to increase the conversion rate, the reaction period is prolonged, causing low utilization rate of polymerization equipment and influencing production speed. Therefore, the method of increasing the temperature at later stage of polymerization is adopted, namely secondary heating is performed for promoting the monomers to accelerate polymerization. Wherein the benzoyl peroxide begins to decompose at 60° C. and volatilizes at 93° C., and is subject to homolysis two free benzoyloxy groups when being heated so as to further eliminate carbon dioxide to form free phenyl groups. Therefore, after the temperature is heated, a low temperature initiating agent fails, so that a high temperature initiating agent is required to be added for shortening the production time and increasing the production efficiency.

At the same time, it is not easy to control the molecular weight of the polymers by the one and half step process in the process of production; although the initiating agent, can be used for controlling the molecular weight of the plant grains, e.g., reducing the use quantity of the initiating agent for increasing the molecular weight, reducing the use quantity of the initiating agent can influence the polymerization time and the conversion rate of the polymers. Therefore, to satisfy the requirements of strength and rigidity (the molecular weight of the polymers required by the present invention is preferably between 150000 and 320000), while selecting the initiating agent with the above parts by weight, the molecular weight regulator having the effect of increasing the molecular weight is introduced into the present invention for solving the technical problem of difficulty in increasing the molecular weight.

From the above, the special modified expandable polystyrene copolymer particle for the lost foam and the production method therefor of the present invention have the excellent advantages of reducing or even avoiding the generation the effect of the carbon defect problem during foundry of the casting, increasing the molecular weight, enabling the quality of the polymers to be stabler, reducing maintenance difficulty and expense of the equipment, increasing the production efficiency, shortening the production process, reducing the energy consumption increasing the automation degree, facilitating operational control, reducing the production cost, etc.

### DETAILED DESCRIPTION

With reference to the following embodiments, the special modified expandable polystyrene copolymer particle for the lost foam and the production method therefor of the present invention are further described.

### Embodiment 1

120 parts of water, 95 parts of styrene, 5 parts of methyl methacrylate, 1 part of suspension concentrate, 0.01 part of anionic surfactant, 0.2 part of benzoyl peroxide, 0.1 part of nucleator, 0.3 part of organic bromine, 0.2 part of dicumyl peroxide, 0.1 part of tert-butyl peroxybenzoate and 0.05 part of molecular weight regulator are taken (by weight); then, the water, the suspension concentrate, the surfactant, the styrene, the methyl methacrylate, the benzoyl peroxide, the nucleator, the organic bromine, the dicumyl peroxide and the tert-butyl peroxybenzoate are successively added into a reaction kettle and uniformly mixed after being covered.

Later, the reaction kettle is heated at the temperature rise speed of 0.5° C./minute; and when the temperature rises to 83° C., constant temperature is kept for 400 minutes.

After covering, the material is replaced with nitrogen three times and 6 parts of foaming agents are pressed in.

Later, the reaction kettle is heated at the temperature rise speed of 0.5° C./minute so that the reaction temperature reaches 120° C. and the pressure reaches 0.65 mpa; and the temperature and the pressure are kept for 300 minutes.

Later, the reaction kettle is cooled with cooling water so that the temperature of the material in the kettle is lowered to 35° C.

Then, the material is dehydrated, dried and screened. Later, 0.3 part of surface coating agent is added and stirred so that the material and the surface coating agent are thoroughly mixed uniformly and then packaged to obtain the special modified expandable polystyrene copolymer particle for the lost foam.

### Embodiment 2

110 parts of water, 95 parts of styrene, 5 parts of methyl methacrylate, 1.5 parts of suspension concentrate, 0.02 part of anionic surfactant, 0.3 part of benzoyl peroxide, 0.2 part of nucleator, 0.4 part of organic bromine, 0.3 part of dicumyl peroxide, 0.2 part of tert-butyl peroxybenzoate and 0.08 part of molecular weight regulator are taken (by weight); then, the water, the suspension concentrate, the surfactant, the styrene, the methyl methacrylate, the benzoyl peroxide, the nucleator, the organic bromine, the dicumyl peroxide and the tert-butyl peroxybenzoate are successively added into a reaction kettle and uniformly mixed after being covered.

Later, the reaction kettle is heated at the temperature rise speed of 0.6° C./minute; and when the temperature rises to 85° C., constant temperature is kept for 480 minutes.

After covering, the material is replaced with nitrogen three times and 5 parts of foaming agents are pressed in.

Later, the reaction kettle is heated at the temperature rise speed of 0.6° C./minute so that the reaction temperature reaches 125° C. and the pressure reach 0.7 mpa; and the temperature and the pressure are kept for 240 minutes.

Later, the reaction kettle is cooled with cooling water so that the temperature of the material in the kettle is lowered to 40° C.

Then, the material is dehydrated, dried and screened.

Later, 0.35 part of surface coating agent is added and stirred so that the material and the surface coating agent are thoroughly mixed uniformly and then packaged to obtain the special modified expandable polystyrene copolymer particle for the lost foam,

### Embodiment 3

110 parts of water, 7 parts of styrene, of methyl methacrylate, 1.5 parts of suspension concentrate, 0.02 part of anionic surfactant, 0.3 part of benzoyl peroxide, 0.2 part of nucleator, 0.4 part of organic bromine, 0.3 part of dicumyl peroxide, 0.2 part of tert-butyl peroxybenzoate and 0.01 part of molecular weight regulator are taken (by weight) then, the water, the suspension concentrate, the surfactant, the styrene, the methyl methacrylate, the benzoyl peroxide, the nucleator, the organic bromine, the dicumyl peroxide and the tert-butyl peroxybenzoate are successively added into a reaction kettle and uniformly mixed after being covered.

Later, the reaction kettle is heated at the temperature rise speed of 0.4° C./minute and when the temperature rises to 85° C., constant temperature is kept for 510 minutes.

After covering, the material is replaced with nitrogen three times and 10 parts of foaming agents are pressed in.

Later, the reaction kettle is heated at the temperature rise speed of 0.4° C./minute so that the reaction temperature reaches 125° C. and the pressure reaches 0.7 mpa; and the temperature and the pressure are kept for 240 minutes.

Later, the reaction kettle is cooled with cooling water so that the temperature of the material in the kettle is lowered to 40° C.

Then, the material is dehydrated, dried and screened.

Later, 0.35 part of surface coating agent is added and stirred so that the material and the surface coating agent are thoroughly mixed uniformly and then packaged to obtain the special modified expandable polystyrene copolymer particle for the lost foam.

### Embodiment 4

120 parts of water, 97 parts of styrene, 3 parts of methyl methacrylate, 2 parts suspension concentrate, 0.05 part of anionic surfactant, 0.4 part of benzoyl peroxide, 0.25 part of nucleator, 0.6 part of organic bromine, 0.5 part of dicumyl peroxide, 0.25 part of tert-butyl peroxybenzoate and 0.1 part of molecular weight regulator are taken (by weight); then, the water, the suspension concentrate, the surfactant, the styrene, the methyl methacrylate, the benzoyl peroxide, the nucleator, the organic bromine, the dicumyl peroxide and the tert-butyl peroxybenzoate are successively added into a reaction kettle and uniformly mixed after being covered.

Later, the reaction kettle is heated at the temperature rise speed of 0.8° C./minute; and when the temperature rises to 90° C., constant temperature is kept for 560 minutes,

After covering, the material is replaced with nitrogen three times and 7 parts of foaming agents are pressed in.

Later, the reaction kettle is heated at the temperature speed of 0.8° C./minute so that the reaction temperature reaches 120° C. and the pressure reaches 0.75 mpa; and the temperature and the pressure are kept for 350 minutes.

Later, the reaction kettle is cooled with cooling water so that the temperature of the material in the kettle is lowered to 38° C.

Then, the material is dehydrated dried and screened.

Later, 0.4 part of surface coating agent is added and stirred so that the material and the surface coating agent are thoroughly mixed uniformly and then packaged to obtain the special modified expandable polystyrene copolymer particle for the lost foam.

### Embodiment 5

100 parts of water, 95 parts of styrene, 5 parts of methyl methacrylate, 1 part of suspension concentrate, 0.02 part of anionic surfactant, 0.35 part of benzoyl peroxide, 0.2 part of nucleator, 0.8 part of organic bromine, 0.35 part of dicumyl peroxide, 0.15 part of tert-butyl peroxybenzoate and 0.05 part of molecular weight regulator are taken (by weight); then, the ate the suspension concentrate, the surfactant, the styrene, the methyl methacrylate, the benzoyl peroxide, the nucleator, the organic bromine, the dicumyl peroxide and the tert-butyl peroxybenzoate are successively added into a reaction kettle and uniformly mixed after being covered.

Later, the reaction kettle is heated at the temperature rise speed of 0.7° C./minute; and when the temperature rises to 85° C., constant temperature is kept for 450 minutes.

After covering, the material is replaced with nitrogen three times and 9 parts of foaming agents are pressed in.

Later, the reaction kettle is heated at the temperature rise speed of 0.7° C./minute so that the reaction temperature reaches 127° C. and the pressure reaches 0.8 mpa; and the temperature and the pressure are kept for 200 minutes.

Later, the reaction kettle is cooled with cooling water so that the temperature of the material in the kettle is lowered to 35° C.,

Then, the material is dehydrated dried and screened.

Later, 0.35 part of surface coating agent is added and stirred so that the material and the surface coating agent are thoroughly mixed uniformly and then packaged to obtain the special modified expandable polystyrene copolymer particle for the lost foam.

### Embodiment 6

110 parts of water, 96 parts of styrene, 4 parts of methyl methacrylate, 2 parts of suspension concentrate, 0.04 part of anionic surfactant, 0.3 part of benzoyl peroxide, 0.15 part of nucleator 1.0 part of organic bromine, 0.4 part of dicumyl peroxide, 0.2 part of tert-butyl peroxybenzoate and 0.08 part of molecular weight regulator are taken (by weight); then, the water, the suspension concentrate, the surfactant, the styrene, the methyl methacrylate, the benzoyl peroxide, the nucleator, the organic bromine the dicumyl peroxide and the tert-butyl peroxybenzoate are successively added into a reaction kettle and uniformly mixed after being covered.

Later, the reaction kettle is heated at the temperature rise speed of 0.6° C./minute; and when the temperature rises to 90° C., constant temperature is kept for 600 minutes.

After covering, the material is replaced with nitrogen three times and 8 part foaming agents are pressed in.

Later, the reaction kettle is heated at the temperature e speed of 0.6° C./minute so that the reaction temperature reaches 125° C. and the pressure reaches 0.75 mpa; and the temperature and the pressure are kept for 240 minutes,

Later, the reaction kettle is cooled with cooling water so that the temperature of the material in the kettle is lowered to 38° C.

Then, the material is dehydrated, dried and screened.

Later, 0.4 part of surface coating agent is added and stirred so that the material and the surface coating agent are thoroughly mixed uniformly and then packaged to obtain the special modified expandable polystyrene copolymer particle for the lost foam.

The mentioned above s preferred embodiments of the present invention. Several variants and improvements can also be made by those skilled in the art without departing from the principle of the present invention and shall be regarded as the protection scope of the present invention.

We claim:

1. A special modified expandable polystyrene copolymer particle for a lost foam, characterized by comprising the following parts by weight: 90 to 100 parts of styrene; 3 to 8 parts of methyl methacrylate; 100 to 140 parts of deionized water; 0.2 to 0.5 part of benzoyl peroxide, 0.2 to 0.5 part of dicumyl peroxide; 0.1 to 0.5 part of tert-butyl peroxybenzoate; 0.001 to 0.01 part of anionic surfactant; 1 to 2 parts of suspension concentrate: 5.0 to 10.0 parts of foaming agent; 0.1 to 0.4 part of nucleator, 0.2 to 2 parts of organic bromine, 0.01 to 0.1 part of molecular weight regulator having the effect of increasing molecular weight, and 0.3 to 0.5 part of surface coating agent.

2. The special modified expandable polystyrene copolymer particle for the lost foam according to claim 1, characterized in that: the organic bromine is any of hexabromocyclododecane, tetrabromocyclooctane, tetrabromoethane and tetrabromophenol bis A/2/4/6-tribromo alkylphenyl allyl ether.

3. The special modified expandable polystyrene copolymer particle for the lost foam according to claim 2, characterized in that: the organic bromine is hexabromocyclododecane.

4. The special modified expandable polystyrene copolymer particle for the lost foam according to claim 1, characterized in that: the molecular weight regulator is any of o-divinylbenzene, ethyleneglycol dimethacrylate and alkyl sulfhydryl or mixtures thereof.

5. The special modified expandable polystyrene copolymer particle for the lost foam according to claim 4, characterized in that: the molecular weight regulator is dodecyl mercaptan.

6. The special modified expandable polystyrene copolymer particle for the lost foam according to claim 1, characterized in that the anionic surfactant is any of lauryl sulfate, stearate, dodecylbenzene sulfonate and dodecyl sulfonate; the nucleator is granular and powdery polyolefin or polyolefin with small straight chains and branched chains; the foaming agent is any of butane, n-pentane, isopentane, cyclopentane, n-hexane, dichloromethane and fluorinated hydrocarbon or mixtures thereof; the surface coating agent is any of zinc stearate and aliphatic glyceride or mixtures thereof; the suspension concentrate is any of water-insoluble inorganic compound or water-soluble high molecular polymer; and the molecular weight regulator is any of o-divinylbenzene, ethyleneglycol dimethacrylate and alkyl sulfhydryl or mixtures thereof.

7. The special modified expandable polystyrene copolymer particle lost foam according to claim 6, characterized in that: the anionic surfactant is sodium dodecyl benzene sulfonate; the nucleator is polyethylene wax; the surface coating agent is a mixture of zinc stearate and aliphatic glyceride; the foaming agent is a mixture of n-pentane, isopentane and cyclopentane; and the suspension concentrate is tricalcium phosphate.

8. The special modified expandable polystyrene copolymer particle for the lost foam according to claim 7, characterized in that: the proportion of the zinc stearate to the aliphatic glyceride is 1:1; the proportion of the n-pentane to the isopentane is (3 to 7):(7to 3), and 0 to 0.5 part of cyclopentane is contained.

9. A production method for preparing the special modified expandable polystyrene copolymer particle for the lost foam according to claim I characterized by successively comprising the following steps:
step 1: adding the deionized water into a reaction kettle; while stirring, successively adding the suspension concentrate, the surfactant, the styrene, the methyl methacrylate, the benzoyl peroxide, the nucleator, the organic bromine, the molecular weight regulator, the dicumyl peroxide and the tert-butyl peroxybenzoate; after covering, uniformly mixing the same;
step 2: heating the reaction kettle at the temperature rise speed of 0.4 to 0.8° C./minute; and when the temperature rises to 80 to 90° C., keeping constant temperature for 400 to 600 minutes;
step 3: after covering, replacing with nitrogen three times and pressing in the foaming agent;
step 4: heating the reaction kettle at the temperature rise speed of 0.4 to 0.8° C./minute so that the reaction temperature reaches 120 to 130° C. and the pressure reaches 0.65 to 0.95 mpa: and keeping the temperature and the pressure for 200 to 300 minutes;
step 5: cooling the reaction kettle with cooling water so that the temperature of the material in the kettle is lowered to 35 to 40° C.; and then, dehydrating, drying and screening the material;
step 6: adding and stirring the surface coating agent so that the material and the surface coating agent are thoroughly mixed uniformly.
